(19) United States
(12) Patent Application Publication
(10) Pub. No.: US 2020/0077281 A1
(43) Pub. Date: Mar. 5, 2020

(54) ROBUSTNESS-ADAPTIVE ACCESS NETWORK

(71) Applicant: Telefonaktiebolaget LM Ericsson (publ), Stockholm (SE)

(72) Inventors: Bo BURMAN, Upplands Väsby (SE); Ralf KELLER, Würselen (DE)

(73) Assignee: Telefonaktiebolaget LM Ericsson (publ), Stockholm (SE)

(21) Appl. No.: 16/347,125

(22) PCT Filed: Oct. 20, 2017
(86) PCT No.: PCT/SE2017/051034

§ 371 Date: May 2, 2019

Related U.S. Application Data
(60) Provisional application No. 62/417,433, filed on Nov. 4, 2016.

(51) Int. Cl. H04W 24/02; H04W 28/10; H04L 1/00; H04W 36/16; H04W 8/24

(52) U.S. Cl. CPC H04W 24/02; H04W 28/10; H04W 8/24; H04W 36/165; H04L 1/0014

(57) ABSTRACT

A method involving a terminal (110) and an access network node (160) in an access network (100) for connecting said terminal (110) to the access network node (160) and wherein said terminal (110) and access network (100) is configurable to support and being adaptive to a plurality of robustness levels. Each robustness level corresponds to a transmission delay and loss limit which can be configured per individual traffic flow. Robustness levels for the terminal and the access network are exchanged in order optimize the end-to-end Quality of Experience, QoE. This is applicable to access networks that show large variations in terms of network performance (for example radio access networks).

### 1 TECHNICAL FIELD

Embodiments herein relate to a robust configurable access network involving terminals and access network nodes configured to support a plurality of robustness levels.

### 2 BACKGROUND

All networks are using some physical access technology and thus have physical limitations, where the perceived severity of those limitations typically depend on the (relative) amount of variation they impose on whatever characteristics that are defined as “network performance”. These physical limitations are typically present in any access network that makes use of an inherently limited, physical resource, such as e.g. radio, where the available amount of the physical resource varies based on several different (physical) conditions. For example, the number of physical conditions affecting optical fiber access networks are rather few and are generally very stable, which means that the network performance exhibits low variation. Radio access networks is an example of access network technology where several conditions show large variation, which also means that the network performance also varies a lot.

A network must in general be usable by as many types of terminals and applications as possible, while still providing economy of scale and that usually results in same treatment of all traffic. This typically means that some terminals and/or applications receive less-than-optimal treatment.

Even if there exist differentiated QoS treatment of traffic, such as in LTE networks, typically a small number of different handling options are pre-defined. QoS handling typically assumes a certain split of robustness between network and terminal. For example, most QCI characteristics currently standardized by 3GPP are pre-defined to certain delay and loss rate values suitable for media (codecs) and latencies that were state-of-the-art when those QCI specifications were written.

A terminal or application can have a-priori knowledge of or observe the QoS provided by the network and adapt its media handling to that. One of the major reasons for such adaptation is a general desire to send as little information as possible from sender to receiver, under the assumption that transporting information comes with a cost that is somehow proportional to the amount of information. A network with high loss can often be mitigated by sending more (redundant) information, which can become costly and may not even be possible, in cases of limited network ability to send enough information per time unit to make all needed information reach the receiver in time. On the other hand, including such redundant information on a network with low loss is thus just an unnecessary cost. Using an amount of redundant information that matches the network quality is therefore desirable to be able to optimize the overall cost of network transport. This optimized approach is generally known since long as “joint-source-channel coding”.

3GPP TS 26.114 defines a (“RTCP-APP”) control message that can be used to communicate a set of different media handling adaptations from a media receiver to a media sender, to be used by the media sender.

Joint-source-channel coding was typically applied to network-integrated and network-aware services and their encoded format in the highly optimized access networks designed at least a decade ago. Since then, the trend has generally been to keep service (application) and network to clearly separate layers, with as little knowledge of one another as possible, which in many ways is a feasible and desirable concept that allows for simple networks and terminals. In other ways, it can also be an over-simplification that encourages sub-optimizations.

Technology development has pushed the borders of what is possible, both in the network and in the terminal, and the hard-coded approach for what QoS “characteristics” an access network provides no longer seems appropriate in all cases. This is effectively a step back towards less separation of services and network that could enable better optimization of quality and resource usage.

For example, when an access network with inherently varying performance is implemented to generally provide a certain maximum loss and delay (level of impairment), under the assumption of a certain terminal ability to handle that level of network impairment, the network may take autonomous decisions to handle what it assumes to be a too high level of impairment. This can e.g. be triggering handover to other access technologies (if such are available), which may be sub-optimal and thus not always appropriate, considering that a terminal may have a preference to continue using the original access even though the provided network quality is “bad” in one or more aspects. The terminal may, e.g. due to technology evolution, include the ability to cope with such “bad” quality for the “failing” aspects of whatever QoS concept is used by the terminal and the service.

Thus, while a terminal or application can know or observe the network behavior, it often has very limited ability, if any, to impact the network to deviate from “default” traffic treatment.

### 3 BRIEF DESCRIPTION OF THE DRAWINGS

FIG. 1 is a block diagram illustrating an embodiment of a robustness configurable access network and a plurality of terminals.

FIGS. 2 and 2b is are flow diagrams illustrating two embodiments of a method for an aware terminal to learn about a robustness configurable access network.

FIG. 3 is a flow diagram illustrating an embodiment of a method for adapting an aware terminal to new robustness levels received from the robustness configurable access network.

FIG. 4 is a block diagram illustrating an embodiment of an aware terminal.

FIG. 5 is a block diagram illustrating an embodiment of an access network node.

FIG. 6 is block diagram illustrating a communication system comprising an access network node, a terminal and a host computer.

FIG. 7 is block diagram illustrating an embodiment of a host computer.

### 4 DESCRIPTION

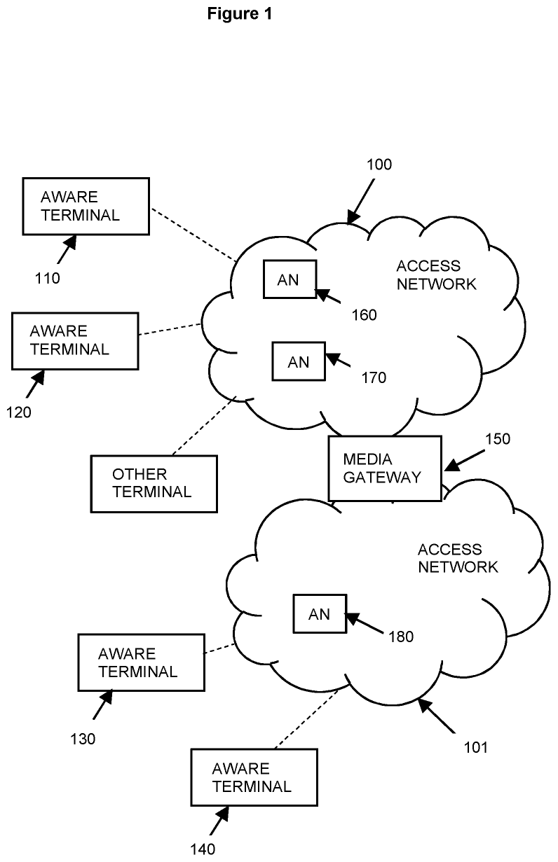

The proposed solution builds on several pre-conditions being fulfilled, which are thus an integrated part of the solution:
The access network 100 or 101 in FIG. 1 is comprising at least one Access network Node (AN) 160,170 or 180 designed such that it is capable to provide a set of different delay and loss limit targets (“robustness levels”), which can be configured per individual traffic flow (henceforth referred to as “robustness configurable access network”). The access network 100 can, for example, be a radio access network.
In this context, an access network node (AN) can be any node within the access network 100, 101 including a gateway node 150 involved in exchanging the traffic flow.
The sets of different delay and loss limits, robustness levels, can be ranked and ordered with respect to what “quality” they provide, based on some suitable rating scale, for example based on regular Mean Opinion Score (MOS) scale ranging from “bad” to “excellent”, or as another example as some dimensionless value where an increasing value indicates increasing robustness.
While the access network 100 can be configured with different robustness levels, it is, as explained above, generally not expected that it is capable to always fulfill such level. This means that while the access network can be configured for a certain robustness level, it is possible that only a “worse” level can be met at a given point in time.
At least some terminals 110,120 that are using the access network 100 have inherent knowledge that the access network may be a robustness configurable access network that is capable to provide configurable robustness levels.
The terminals 110, 120 that have knowledge of this configuration possibility (henceforth referred to as “aware terminal”) have:
   Implemented at least one method to learn whether the network provides configurable robustness levels.
   Implemented at least one method to provide the network with information about what (configurable) robustness levels it can handle for the traffic flows it intends to send and receive.
   Implemented capability to receive and understand information from the network about what robustness levels the network is currently able to provide.
   Implemented methods to adapt its sending and/or receiving of traffic flows to meet and possibly mitigate negative effects from the different robustness levels affecting the sent and/or received traffic flows.

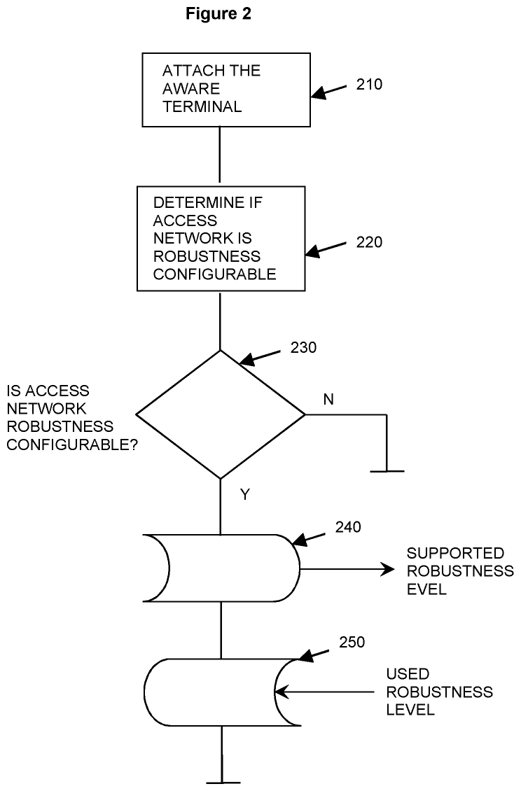

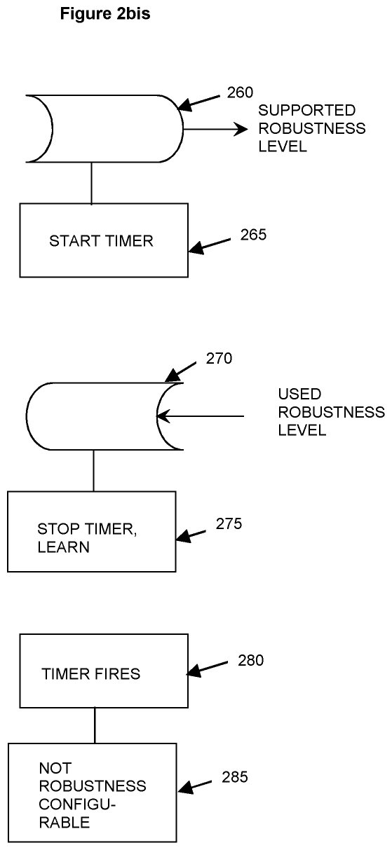

When an aware terminal 110 attaches in step 210 (see FIG. 2) to such configurable access network 100:
The aware terminal 110 learns in step 220 if the network it attaches to is a robustness configurable access network 100 or not. If it is not a robustness configurable access network, step 230, this solution does not apply and no further action related to this solution is taken.
The aware terminal 110 informs in step 240 the configurable access network 100 what robustness level it can handle.
The robustness configurable access network 100 informs in step 250 the aware terminal 110 what robustness level it can use.

An alternative to determine if the access network 100 is a robustness configurable access network is illustrated by FIG. 2b is and a number of sub steps 260-285 to step 220. The aware terminal 110 sends in sub step 260 what robustness level it can handle to the access network 100 and starts in sub step 265 a timer. If the aware terminal 110 receives a robustness level in sub step 270, it learns that the access network 100 is a robustness configurable access network and stops the timer in sub step 275. If no response is received, the timer fires in sub step 280, and the aware terminal 110 learns in sub step 285 that the access network 100 is not a robustness configurable access network.

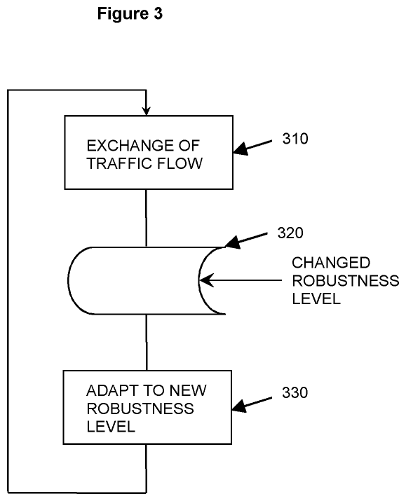

When an aware terminal 110 sends and/or receives a traffic flow in step 310 (see FIG. 3) through the robustness configurable access network 100:
The robustness configurable access network 100 communicates to the aware terminal 110 in step 320 what robustness level it currently uses for this specific traffic flow whenever the level changes. This principle to communicate any new information applies dynamically for the lifetime of the traffic flow, such that if the robustness configurable access network 100 starts using another robustness level for an ongoing traffic flow, the aware terminal 110 is informed about that. The robustness level is considered changed also when the traffic flow starts.
The robustness configurable access network 100 uses the robustness level information of the aware terminal 110 for example to adjust the decision logic on when to perform handover to a different radio cell within the same radio technology, to a different radio technology and even when to initiate SRVCC.
The aware terminal 110 dynamically chooses a way to adapt in step 330 its sending and/or receiving of that traffic flow to, as best it can, match the robustness level it got information about. The nature of such traffic flow content adaptation depends on what types of adaptation that is available to use and is understood by both traffic flow sender and traffic flow receiver. The aware terminal 110 is always one of those. An example of the other entity in the media path that communicates with the aware terminal can, for example, be a media gateway 150, or can alternatively be another terminal 120, either one of which supports the chosen type of content adaptation.
When the chosen content adaptation is suitable to use within the access network 100, but would be inefficient or sub-optimal on other parts of the end-to-end media path, it can be feasible to use a media gateway 150 to terminate the content adaptation, thereby limiting use of content adaptation to the applicable part of the end-to-end media path.
The media gateway 150 may also be connected to access network 101 which also is a robustness configurable access network having aware terminals 130,140 and where said access network 101 may use a different robustness level than access network 100.
Traffic flow content adaptation can for example consist of, but is not limited to:
   Choosing a content encoding format (codec type and configuration) that is inherently more or less robust to loss
   Choosing what amount, if any, and what forward error correction algorithms (from simple repetition codes to complex transforms) to apply to the content
   Choosing the maximum number of content retransmissions to perform at loss of content that will still fit within some (application-specific) maximum end-to-end latency

The solution is therefore a way to dynamically communicate targeted network characteristics, such as delay and loss, for a traffic flow between a network 100 and a terminal 110,120, such that the terminal 110,120 can use the explicitly communicated network characteristics to optimize handling of the traffic flow without having to guess or infer such network characteristics.

While there is no generally useful, single message that can be used to request or inform about usage of media adaptations between media sender and media receiver, there are several different, already defined messages that can be used to solve parts of the problem. For example, the “RTCP-APP” message defined in 3GPP TS 26.114 (mentioned above) does not describe in detail what triggers to use to start or stop adaptation, or how to choose which one or ones of the different media handling adaptations to use.

The aware terminal 110, 120 may be any device intended for accessing services via an access network and configured to communicate over the access network. For instance, the terminal may be, but is not limited to: mobile phone, smart phone, sensor device, meter, vehicle, household appliance, medical appliance, media player, camera, or any type of consumer electronic, for instance, but not limited to, television, radio, lighting arrangement, tablet computer, laptop, or PC. The terminal may be a portable, pocket-storable, hand-held, computer-comprised, or vehicle-mounted mobile device, enabled to communicate voice and/or data, via a wireless or wireline connection.

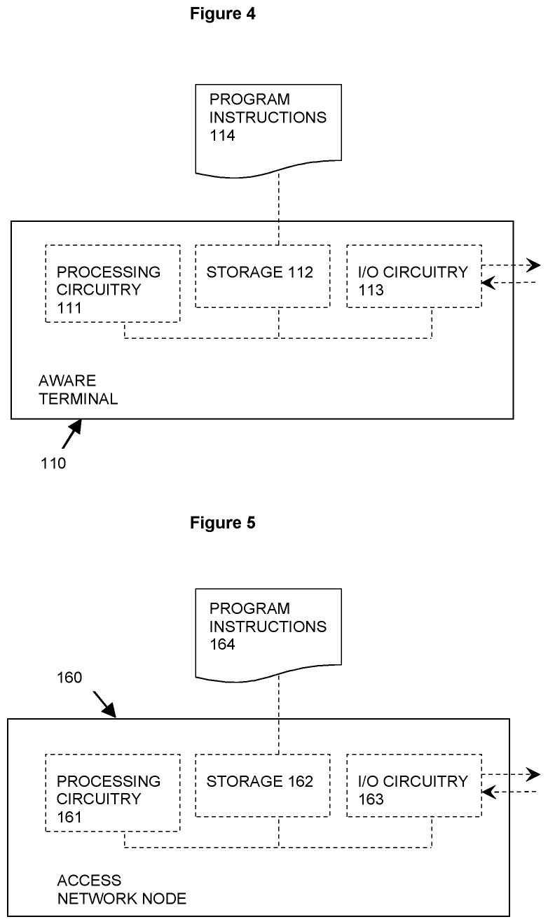

FIG. 4 is a block diagram illustrating an embodiment of an aware terminal 110 comprising processing circuitry 111, computer-readable storage medium 112 and i/o circuitry 113. The processing circuitry 111 may include, for example, one or more central processing units (CPUs), one or more microprocessors, one or more application specific integrated circuits (ASICs), and/or one or more field programmable gate arrays (FPGAs). Examples of computer-readable storage medium 112 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or any other volatile or non-volatile, non-transitory computer-readable and/or computer-executable memory devices that store information, data, and/or instructions that may be used by processing circuitry 111. In some embodiments, processing circuitry 111 and computer-readable storage medium 112 may be considered to be integrated.

The I/O circuitry 113 may include RF transceiver circuitry if the terminal is a wireless terminal in a radio access network.

In particular embodiments, some or all of the functionality described herein as being provided by the aware terminal 110 may be provided by the processing circuitry 111 executing instructions 114 stored on the computer-readable storage medium 112.

The access network node 160, 170 in the access network 100 may be a radio base station, a wireless router, or a wireline access network node designed such that it is capable to provide a set of different delay and loss limit targets (“robustness levels”), which can be configured per individual traffic flow.

FIG. 5 is a block diagram illustrating an embodiment of access network node 160 comprising processing circuitry 161, computer-readable storage medium 162 and i/o circuitry 163. The processing circuitry 161 may include, for example, one or more central processing units (CPUs), one or more microprocessors, one or more application specific integrated circuits (ASICs), and/or one or more field programmable gate arrays (FPGAs). Examples of computer-readable storage medium 112 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or any other volatile or non-volatile, non-transitory computer-readable and/or computer-executable memory devices that store information, data, and/or instructions that may be used by processing circuitry 161. In some embodiments, processing circuitry 161 and computer-readable storage medium 162 may be considered to be integrated.

The I/O circuitry 163 may include RF transceiver circuitry if the access network node 160 is located in a radio access network.

In particular embodiments, some or all of the functionality described herein as being provided by the access network node 160 may be provided by the processing circuitry 161 executing instructions 164 stored on the computer-readable storage medium 162.

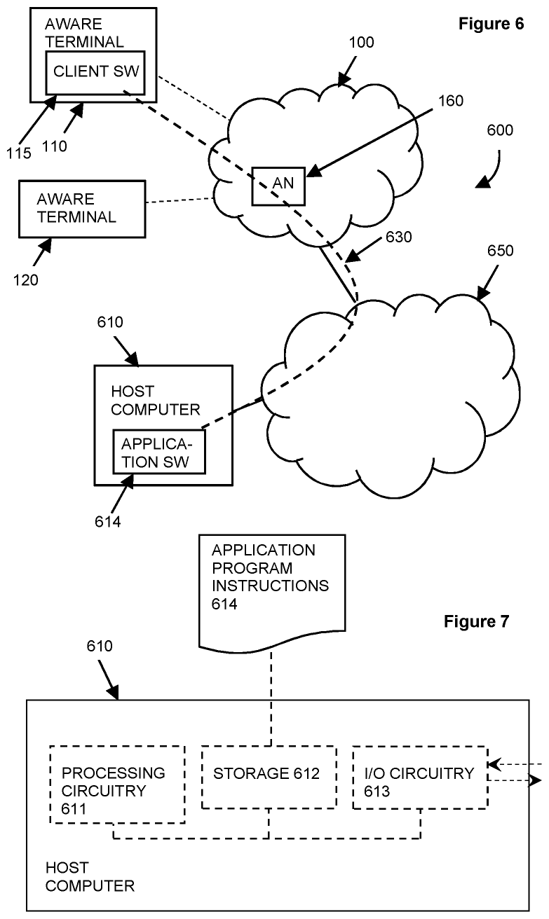

FIG. 6 illustrates a communication network 600 comprising the access network 100 with terminals 110,120 and access nodes 160. It also comprises a core network 650 to which the access network 100 is connected. Connected to the core network 650 is also a host computer or server 610 normally owned by a service provider. The host computer 610 comprises application software 614 which can communicate and serve clients 115 in the terminals 110 in the access network 100. The client software instructions 115 are stored in the computer-readable storage medium 112 in the terminal 110. The host computer 610, the terminal 110 and the access node 160 forms a communication system for providing services and/or data to a user of the terminal 110. The two-way communication and/or data flow 630 between the client 115 and application 614 passes the intermediary access node 160 and makes use of the described robustness levels supported by the terminals 110 and the access network nodes 160 in the access network 100 as described above.

FIG. 7 is a block diagram illustrating an embodiment of the host 610 comprising processing circuitry 611, computer-readable storage medium 612 and i/o circuitry 613. The processing circuitry 611 may include, for example, one or more central processing units (CPUs), one or more microprocessors, one or more application specific integrated circuits (ASICs), and/or one or more field programmable gate arrays (FPGAs). Examples of computer-readable storage medium 612 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or any other volatile or non-volatile, non-transitory computer-readable and/or computer-executable memory devices that store information, data, and/or instructions that may be used by processing circuitry 611. In some embodiments, processing circuitry 611 and computer-readable storage medium 612 may be considered to be integrated. The I/O circuitry 613 may comprise NICs, Network Interface Cards providing IP connectivity to the core network 650.

The computer-readable storage medium 612 in the host computer comprises the application program instructions 614.

Among the advantages, and the added value to the communication system in FIG. 6, the proposed solution provides a better overall optimization of end-to-end Quality of Experience in the presence of non-perfect network transport (such as radio), enabling a better distribution of functionality between the network and the terminal than what is currently typically possible.

Examples of applications: Conversational speech and video services such as VoLTE/ViLTE, where low end-to-end latency must be combined with high media QoE and/or QoS, efficient use of access network resources, and where the serving (Radio) Access Network(s) can be configured with a latency-QoE (robustness) trade-off based on User Equipment capability and configuration.

### 5 ABBREVIATIONS

| Abbreviation | Explanation |
|---|---|
| LTE | Long-Term Evolution |
| NIC | Network Interface Card |
| QCI | QoS Class Identifier |
| QoE | Quality of Experience, a measure of a |
| | customer's experiences with a service |
| QoS | Quality of Service |
| RF | Radio Frequency |
| RTCP | Real-time Transport Control Protocol |
| RTCP-APP | Application-defined RTCP |
| SRVCC | Single Radio Voice Call Continuity |
| ViLTE | Video over Long-Term Evolution |
| VoLTE | Voice over Long-Term Evolution |
| 3GPP | 3rd Generation Partnership Project |

1. A terminal configured to be connected to an access network node in an access network said access network being configurable to support a plurality of robustness levels, wherein each robustness level corresponds to a transmission delay and loss limit which can be configured per individual traffic flow, the terminal being further configurable to support at least one robustness level and wherein the terminal is comprising a processor circuitry coupled to a non-transitory memory storing computer program instructions wherein when the processor circuitry executes the instructions, the terminal is caused to:
determine if the access network provides configurable robustness levels;
if the access network provides configurable robustness levels, send in a first message to the access network node the robustness level the terminal can handle when receiving or sending a traffic flow;
receive in response to the first message a second message from the access network node comprising a first robustness level the access network can use when receiving or sending a traffic flow;
receive from the access network node a third message with a second robustness level that the access network currently is using for a specific traffic flow; and
adapt the reception and the sending of the traffic flow from the first to the second robustness level.

2. The terminal of claim 1, further configured to adapt the reception and the sending of the traffic flow by choosing a different codec type or codec configuration or to select a different forward error correction algorithm.

3. The terminal of claim 2, being a mobile terminal configured to be connected to a radio access network node.

4. The terminal of claim 3, wherein the third message with the second robustness level is received as a result of a handover to a different cell or radio technology initiated by the radio access network node.

5. The terminal of claim 3, wherein the third message with the second robustness level is received as a result of Single Radio Voice Call Continuity, SRVCC initiated by the radio access network node.

6. A method in a terminal to communicate with an access network node in an access network said access network being configurable to support a plurality of robustness levels, wherein each robustness level corresponds to a transmission delay and loss limit which can be configured per individual traffic flow, the terminal being configurable to support at least one robustness level, said method comprising the steps of:
determining whether the access network provides configurable robustness levels;
as a result of determining that the access network provides configurable robustness levels, sending in a first message the robustness level the terminal can handle when receiving or sending a traffic flow;
receiving as a response to the first message a second message transmitted by the access network node a first robustness level the access network can use when receiving or sending a traffic flow;
receiving a third message transmitted by the access network node, the third message indicating a second robustness level that the access network currently is using for a specific traffic flow; and
adapting the reception and the sending of the traffic flow from the first to the second robustness level.

7. The method of claim 6, wherein the step of adapting the reception and the sending of the traffic flow is done by choosing a different codec type or codec configuration or selecting a different forward error correction algorithm.

8. The method of claim 7, wherein the terminal is a mobile terminal and the access network node is a radio access network node.

9. The method of claim 8, wherein the third message with the second robustness level is received as a result of a handover to a different cell or radio technology initiated by the radio access network node.

10. The method of claim 8, wherein the third message is received in as a result of Single Radio Voice Call Continuity, SRVCC initiated by the radio access network node.

11. An access network node in an access network being configurable to support a plurality of robustness levels, wherein each robustness level corresponds to a transmission delay and loss limit which can be configured per individual traffic, the network node configured to be connected to at least one terminal and comprising a processor circuitry coupled to a non-transitory memory storing computer program instructions wherein when the processor circuitry executes the instructions, the network node is caused to:
send, in response a first message indicating the robustness level the terminal can handle when receiving or sending a traffic flow, a second message to the terminal with a first robustness level the access network can use when receiving or sending a traffic flow; and
in response to changed robustness level in the access network, send to the terminal a third message indicating a second robustness level that the access network is using for a specific traffic flow.

12. The access network node of claim 11, being a radio access network node.

13. The access network node of claim 12, wherein the step of sending the third message with the second robustness level is done in relation to initiating handover of the terminal to a different cell or radio technology.

14. The access network node of claim 12, wherein the step of sending the third message with the second robustness level is done in relation to initiating Single Radio Voice Call Continuity, SRVCC.

15. A method in an access network node located in an access network to communicate with at least one terminal, said access network being configurable to support a plurality of robustness levels, wherein each robustness level corresponds to a transmission delay and loss limit which can be configured per individual traffic flow, the access network node being further configurable to support a plurality of robustness levels, said method comprising the steps of:
receiving a first message transmitted by the terminal, the first message indicating the robustness level the terminal can handle when receiving or sending a traffic flow;
sending in response to the first message a second message indicating a first robustness level the access network can use when receiving or sending a traffic flow; and
sending to the terminal as a response to changed robustness level in the access network a third message indicating a second robustness level that the access network is using for a specific traffic flow.

16. The method of claim 15, wherein the network node is a radio access network node.

17. The method of claim 16, wherein the step of sending the third message with the second robustness level is done in relation to initiating handover of the terminal to a different cell or radio technology.

18. The method of claim 16, wherein the step of sending the third message with the second robustness level is done in relation to initiating Single Radio Voice Call Continuity, SRVCC.

19. A computer program product comprising a non-transitory computer readable medium storing a computer program comprising computer readable instructions which when executed on a terminal causes the terminal to perform the method of claim 6.

20. (canceled)
